(19) United States
(12) Patent Application Publication
(10) Pub. No.: US 2005/0254827 A1
(43) Pub. Date: Nov. 17, 2005

(54) Backplane for a data communication system, a data communication system, a host and a method of communication

(75) Inventors: Kenneth M. Hopkins, Chichester (GB); Richard C.A. Pitwon, Southsea (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Havant (GB)

(21) Appl. No.: 11/125,341

(22) Filed: May 10, 2005

Related U.S. Application Data
(60) Provisional application No. 60/569,626, filed on May 11, 2004.

(51) Int. Cl. H04B 10/00

(52) U.S. Cl. 398/164

(57) ABSTRACT

The present invention relates to a backplane for a data communication system. The backplane includes ports each for connection to a respective circuit, a common communication channel in communication with each of the ports for transmission of a multiplexed optical signal, and a tuned or tuneable coupler associated with at least one of the ports for selecting in use from the multiplexed signal an optical signal at a wavelength to which the respective coupler is tuned. Selective optical communication between the at least one port and another of the ports via the communication channel is thereby enabled.

### CROSS-REFERENCE TO RELATED APPLICATION

This application relies for priority on U.S. Provisional Patent Application Ser. No. 60/569,626, filed May 11, 2004, the contents of which are incorporated herein by reference.

The present invention relates to a backplane for a data communication system, a data communication system, a host and a method of communication.

In a conventional backplane a copper connector is used for connecting two or more blades of a communication system, a blade being a user circuit board that can be plugged into a backplane. The communication system may be any type of communication system that requires the use of a backplane. Examples include a PC, a storage system, a network router and a network switch. In all cases, inter communication between blades along a backplane is required. In some situations, in the event of a single failure in one or more of the blades, the faulty blade or blades must be bypassed. For example, in the event of single blade failure, the faulty blade must be bypassed. Conventionally, this is implemented by means of port bypass circuitry.

As data rates used for communication in such systems increase, it is anticipated that significant problems will be encountered with the use of copper backplane systems. In particular, there is a limit to the data rate at which copper interconnects are effective. At higher data rates practical implementation using copper interconnects is difficult. To address this, optical backplane systems have been developed. In such systems, multiple blades are distributed along an optical backplane and interconnected via optical channels. A dedicated channel is provided for connections between each pair of blades.

According to a first aspect of the present invention, there is provided a backplane for a data communication system, the backplane comprising: a plurality of ports each for connection to a respective circuit; a common communication channel in communication with each of the plurality of ports for transmission of a multiplexed optical signal; and a tuned or tuneable coupler associated with at least one of the ports for selecting in use from a said multiplexed signal an optical signal at a wavelength to which the respective coupler is tuned thereby enabling selective optical communication between the at least one port and another of the plurality of ports via the communication channel.

The invention provides a backplane for a data communication system in which a common optical communication channel is used to enable selective communication between two or more ports of an associated communication system via the common optical communication channel. This is particularly desirable since this enables conventional port bypass circuitry to be dispensed with. The common communication channel is preferably embodied by an optical waveguide.

In a particularly preferred embodiment, optical wavelength dependent couplers may be used to couple user circuits to the optical waveguide. This then enables the use of methods of communication such as wavelength division multiplexing (WDM). Most preferably, coarse WDM is used.

According to second aspect of the present invention, there is provided a data communication system, the data communication system comprising: a backplane according to the first aspect of the present invention and a plurality of user circuits arranged on the backplane connected to respective ports of the backplane, wherein at least one of the user circuits comprises an optical signal generator for generating an optical signal for communication via the common communication channel of the backplane to a selected one or more of the other user circuits.

According to a third aspect of the present invention, there is provided a host system, comprising a data communication system according to the second aspect of the present invention, wherein the host system is one of a PC, a network switch, a network router and a storage system

According to a fourth aspect of the present invention, there is provided a method of communication between user circuits of a communication system, the communication system comprising a backplane having a plurality of ports each having a user circuit associated therewith and being thereby coupled to a common optical communication channel. The method comprises: transmitting an optical signal from one user circuit via the optical communication channel to a selected other user circuit, wherein the signal is sent at a wavelength at which the other user circuit is tuned to receive signals from the communication channel.

The method of communication according to the present invention enables conventional port bypass circuitry to be dispensed with. Whereas conventionally port bypass circuitry was required, according to the present invention the use of a common optical communication channel together with tuneable couplers enables signals to be selectively sent from one user circuit to another all using the same common communication channel.

According to a further aspect of the present invention, there is provided a backplane for a data communication system, the backplane comprising: a plurality of ports each for receiving a respective circuit; and a common communication channel in communication with the plurality of ports, wherein communication between at least one of the ports and the common communication channel is tuneable to enable selective optical communication between the at least one port and another of the plurality of ports via the communication channel.

Examples of the present invention will now be described in detail with reference to the accompanying drawings, in which:

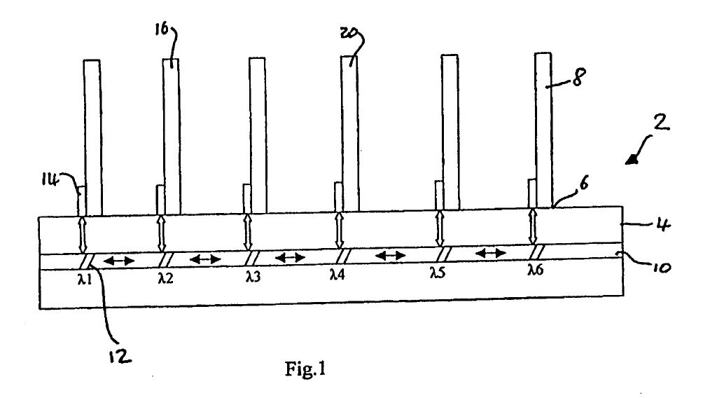

FIG. 1 is a schematic representation of an example of a data communication system according to an embodiment of the present invention; and,

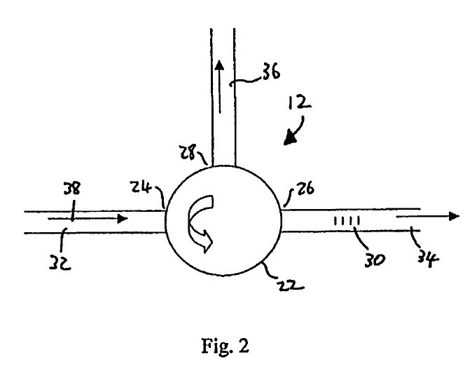

FIG. 2 is a schematic representation of an example of an optical coupler for use in the communication system of FIG. 1.

FIG. 1 is a schematic representation of an example of a communication system according to an embodiment of the present invention. The communication system is of the type that would typically be arranged in a host such as a network switch, a PC or any other such suitable host. The communication system 2 comprises a backplane 4 having a number of ports 6 each for receiving a blade 8 (a circuit such as a user circuit that may be plugged into the backplane). The backplane 4 has a common channel arranged in communication with each of the ports 6. In the example shown the common channel is an optical waveguide 10. The channel serves to provide a common shared path for signals between any two or more of the user circuits.

It will be appreciated that each of the blades may be identical so that adding more blades provides a corresponding increase in performance. Alternatively, one of the blades may function as a central processing unit for the host, the other blades providing peripheral functions. Whether or not all the blades are identical may depend largely on the type of host and the functionality it must provide.

In the example shown, each of the ports 6 has a blade 8 associated therewith. The waveguide 10 has a plurality of tuning elements 12, each associated with one of the ports 6. In the example shown, each of the tuning elements 12 is associated with only one of the ports 6. Each of the tuning elements 12 is tuned to a specific wavelength λ1 to λ6 to enable selective communication between two or more of the blades 8 via their respective ports 6. It may be that two or more of the tuning elements 12 may be tuned to the same wavelength. This will enable the same signal to be sent to two or more of the circuits.

Preferably, each of the blades 8 has an associated transceiver 14 for transmitting and receiving optical signals at a specific wavelength. The transmitters are selectively configurable to enable the transmission wavelength to be selected to correspond to the reception wavelength of one or more of the tuning elements 12 each associated with another blade.

In use, if for example communication is required between the blades numbered 16 and 20, the transceiver 14 of blade 16 couples a signal at wavelength λ4 to the optical waveguide 10 via its port 6. The signal at wavelength λ4 then propagates along the waveguide 10 until it reaches tuning element 12 associated with the blade 20. Since this tuning element is tuned to the wavelength λ4 the signal transmitted at that wavelength from the blade 16 is routed via the tuning element 12 to the transceiver 14 of the blade 20.

The signal at wavelength λ4 will have passed the blade between blades 16 and 20 since the tuning element tuned to wavelength λ3 would not have interfered with the propagation of the signal at wavelength λ4. In other words, the communication system enables individual or plural blades within the communication system to be selectively bypassed without requiring complex port bypass circuitry.

In the example shown in FIG. 1, the waveguide 10 has a plurality of tuning elements 12 shown in this example to be Bragg fibre gratings. Any suitable tuning element may be used to enable selective coupling of signals at specified wavelengths from the waveguide 10 to a selected one or more of the blades 8. In an alternative example, an optical circulator is used in combination with a reflective fibre grating to selectively couple a propagating signal to one of the blades 8. An arrayed-waveguide grating (AWG) may also be used to selectively couple a propagating signal to one of the blades 8.

FIG. 2 shows an example of a tuning element 12 including an optical circulator. The tuning element 12 comprises an optical circulator 22 having three ports 24, 26 and 28. A reflective grating 30 tuned to a desired wavelength is provided downstream of port 26. Waveguide elements 32, 34 and 36 are connected respectively to the ports 24, 26 and 28.

In use, an optical signal 38 propagating along waveguide element 32 is received by the circulator 22. The optical signal is routed to the waveguide element 34. If the wavelength of the signal corresponds to the wavelength of the reflective grating 30, the signal is returned to the optical circulator via port 26 and from there to waveguide element 36. If however, the wavelength of the signal 38 does not correspond to that of the reflective grating 30, it propagates onwards along the waveguide element 34. It will be appreciated that this provides a means for selectively coupling a signal to a blade in a data communication system such as that shown in FIG. 1.

In addition to the backplane and communication system described above, a method is provided by which communication between selected blades within a data communication system can be achieved. In particular, the method enables communication on an optical communication channel between blades of a data communication system in such a way that conventional port bypass circuitry used in copper backplanes may be avoided. The optical communication channel may be shared by all the blades within the communication system.

In the method, a selected one or more of the blades within a data communication system is or are arranged to transmit a signal at a desired wavelength to correspond to the tuning of an associated tuning element within the communication system.

One particularly advantageous method by which communication may be achieved is with the use of wavelength division multiplexing such as Coarse Wavelength Division Multiplexing (CWDM). Use of an optical backplane with CWDM allows for a simpler and lower cost solution both of the backplane itself and of the user circuits i.e. blades. CWDM typically utilises wavelength channels arranged at wavelengths that differ by at least 20 nm. The user circuits can be configured to operate at any of the multiple wavelengths used in the CWDM system thereby allowing point-to-point and one-to-many topologies. Preferably, user circuits are manufactured identically and configured in system, i.e. configured in system to transmit optical signals at particular frequencies/wavelengths.

The use of CWDM technology is particularly advantageous at data rates in the GigaHertz range where conventional copper interconnects become difficult to implement.

Embodiments of the present invention have been described with particular reference to the examples illustrated. However, it will be appreciated that variations and modifications may be made to the examples described within the spirit and scope of the present invention.

1. A backplane for a data communication system, the backplane comprising:
a plurality of ports each for connection to a respective circuit;
a common communication channel in communication with each of the plurality of ports for transmission of a multiplexed optical signal; and
a tuned or tuneable coupler associated with at least one of the ports for selecting in use from a said multiplexed signal an optical signal at a wavelength to which the respective coupler is tuned thereby enabling selective optical communication between the at least one port and another of the plurality of ports via the communication channel.

2. A backplane according to claim 1, wherein the common communication channel comprises an optical waveguide.

3. A backplane according to claim 1, comprising a tuned or tuneable coupler associated with at least one of the ports for coupling to the at least one port an optical signal at a wavelength to which the coupler is tuned.

4. A backplane according to claim 3, comprising a respective tuned or tuneable coupler corresponding to each of two or more of the ports for coupling an optical signal at a desired wavelength to the respective ports.

5. A backplane according to claim 3, in which the common communication channel comprises an optical waveguide and at least one of the tuned or tuneable couplers comprises a Bragg grating arranged on the optical waveguide for selectively coupling a desired wavelength signal to one or more of the ports.

6. A backplane according to claim 3, in which at least one of the tuned or tuneable couplers comprises an optical circulator and a tuneable reflector for coupling a desired wavelength signal to one or more of the ports.

7. A backplane according to claim 4, in which at least one of the tuned or tuneable couplers comprises an arrayed-waveguide grating.

8. A data communication system, the data communication system comprising:
a backplane according to claim 1; and
a plurality of user circuits arranged on the backplane connected to respective ports of the backplane, wherein at least one of the user circuits comprises an optical signal generator for generating an optical signal for communication via the backplane to a selected one or more of the other user circuits.

9. A system according to claim 8, wherein at least one of the user circuits comprises a receiver for receiving and decoding an optical signal received from one or more of the other user circuits.

10. A host system, comprising a data communication system according to claim 7, wherein the host system is at least one of a PC, a network switch, a network router and a storage system.

11. A host system according to claim 9, wherein the system is a PC and the user circuits are blades within the PC.

12. A method of communication between user circuits of a communication system, the communication system comprising a backplane having a plurality of ports each having a user circuit associated therewith and being tuneably coupled to a common optical communication channel, the method comprising:
transmitting an optical signal from one user circuit via the optical communication channel to a selected other user circuit, wherein the signal is sent at a wavelength at which the other user circuit is tuned or tuneable to receive signals from the communication channel.

13. A method according to claim 12, the method comprising transmitting the optical signal via an optical waveguide arranged to receive optical signals from two or more user circuits.

14. A method according to claim 12, the method being executed using a communication system according to claim 8.

15. A method according to claim 12, in which signals are sent between user circuits via the optical communication channel using wavelength division multiplexing.
